(19) United States
(12) Patent Application Publication
(10) Pub. No.: US 2015/0309159 A1
(43) Pub. Date: Oct. 29, 2015

(54) METHOD OF OPERATING A SYSTEM FOR PRECISELY LOCATING AN ASSET POINT IN A PHYSICAL PLANT

(71) Applicant: Johannes Izak BOERHOUT, San Diego, CA (US)

(72) Inventor: Johannes Izak BOERHOUT, San Diego, CA (US)

(73) Assignee: Aktiebolaget SKF, Goteborg (SE)

(21) Appl. No.: 14/261,904

(22) Filed: Apr. 25, 2014

(51) Int. Cl. G01S 5/08; H04Q 9/00; G01S 19/13; G08B 21/02

(52) U.S. Cl. CPC G01S 5/08; G08B 21/0272; H04Q 9/00; G01S 19/13

(57) ABSTRACT

A method of operating a system for precisely locating an asset or measurement point in a physical plant is provided. The steps of operating the system include providing a hand held device having an application disposed thereon; forming a wireless mesh with a plurality of transmitters located at known locations disposed throughout the physical plant; enabling the hand held device to triangulate to a precise location in the physical plant by virtue of the application and wireless mesh; overlaying the precise triangulated location on an asset map displayed on the hand held device, and displaying accurately both the particular asset and particular assets location by knowing its precise location overlaid onto the asset map.

### FIELD OF THE INVENTION

The present disclosure generally relates to a method of operating a system for locating an asset point. More particularly, the present disclosure relates to a method of operating a system for precisely locating an asset point in a physical plant.

### BACKGROUND OF THE INVENTION

Data acquisition with mobile devices in a complex industrial setting can be an expensive and complicated effort. The data acquired might involve measurements on machinery and/or observations (inspections) made by plant personnel. In such a setting, a critical element requires one to know which machinery (asset) one is standing in front of to proceed with the monitoring activity, as well as which part of the machinery should be observed/monitored/taken data on. The set of machinery for observation is generally put together as an instruction list (e.g., go to asset 1, take data at point A, take data at point B, go to asset 2 etc.). This instruction list is commonly referred to as a ‘route’.

Plant personnel are normally trained on the route so they understand which assets are involved and where/how to measure. However, it shall be clear that training personnel on a ‘route’ has a cost associated and is not infallible. Secondly, routes undergo frequent changes as assets go in/out of operation and therefore some amount of retraining is always necessary. Mistakes are easy to make.

### SUMMARY OF THE INVENTION

Embodiments of the disclosure may provide a method of operating a system for precisely locating an asset or measurement point in a physical plant. The method includes the steps of providing a hand held device having an application disposed thereon and forming a wireless mesh with a plurality of transmitters located at known locations disposed throughout the physical plant; enabling the hand held device to triangulate to a precise location in the physical plant by virtue of the application and wireless mesh; overlaying the precise triangulated location on an asset map displayed on the hand held device, and displaying accurately both the particular asset and particular assets location by knowing its precise location overlaid onto the asset map.

In a first aspect of the present invention, displaying a particular assets location including its longitudinal and latitudinal positions.

In a second aspect of the present invention, further including a directional heading displayed on the hand held device is generated by the last physical movement of the hand held device.

In another aspect of the present invention, further comprising a step of an operator making an observation about an asset and having their precise location and heading stored along with their observation is provided.

In yet another aspect of the present invention, further comprising a step of obtaining the asset map through a wireless connection from an internet/intranet server.

In yet another aspect of the present invention, further comprising a step of storing the asset map within the mobile data collector.

In yet another aspect of the present invention, further comprising a step of monitoring the application online.

In yet another aspect of the present invention, further comprising a step of monitoring the application online.

In yet another aspect of the present invention, further comprising a step of the hand held device application communicating with a server application that in turn holds online data.

In yet another aspect of the present invention, further comprising a step of walking past the asset with the hand held device updates information on that asset.

In yet another aspect of the present invention, including when walking past the asset, the application is configured to display life data for that asset.

In yet another aspect of the present invention, a step of locating the hand held device within a range of 20-40 cm of a particular location or asset disposed within the physical plant is provided.

In yet another aspect of the present invention, the measurement point provides telemetry data.

In yet another aspect of the present invention, the telemetry data includes peak, danger and alarm levels.

In yet another aspect of the present invention, temperature levels are taken, displayed and stored for a number of successive days.

In yet another aspect of the present invention, the telemetry data includes peak, danger and alarm levels.

In yet another aspect of the present invention, the telemetry data for a particular asset includes a location, the location providing a heading, a longitudinal position and a latitudinal position.

In yet another aspect of the present invention, the heading is shown as a directional arrow displayed within a compass having north, south east and west divisions.

In yet another aspect of the present invention, the precise device location and device heading of an observation made by a plant personnel is stored within the device along with the observation, and wherein the data and observation made may provide data diagnosis and automation at a later time.

In yet another aspect of the present invention, further comprising a step of using the system to instruct plant personnel where to go next and verify that they have arrived.

### BRIEF DESCRIPTION OF THE DRAWINGS

The invention will now be described, by way of example, with reference to the accompanying drawings, in which:

FIG. 1A is a plan view of a physical plant showing a first part of a system for precisely locating an asset point extending wirelessly from point A according to a preferred embodiment of the present invention;

FIG. 1B is a perspective view of a second part of a system for precisely locating an asset point extending wirelessly from point A according to a preferred embodiment of the present invention;

FIG. 2 is a plan view of a hand held device showing its display according to a preferred embodiment of the present invention;

FIG. 3 is a flow diagram of the method of operating the system according to a preferred embodiment of the present invention; and

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Hence, specific dimensions and other physical characteristics relating to the embodiments disclosed herein are not to be considered as limiting, unless the claims expressly state otherwise. Also, it should be noted that a wire, electrical contact, electrical connector, etc., could be used as the form of electrical communication between internal device components.

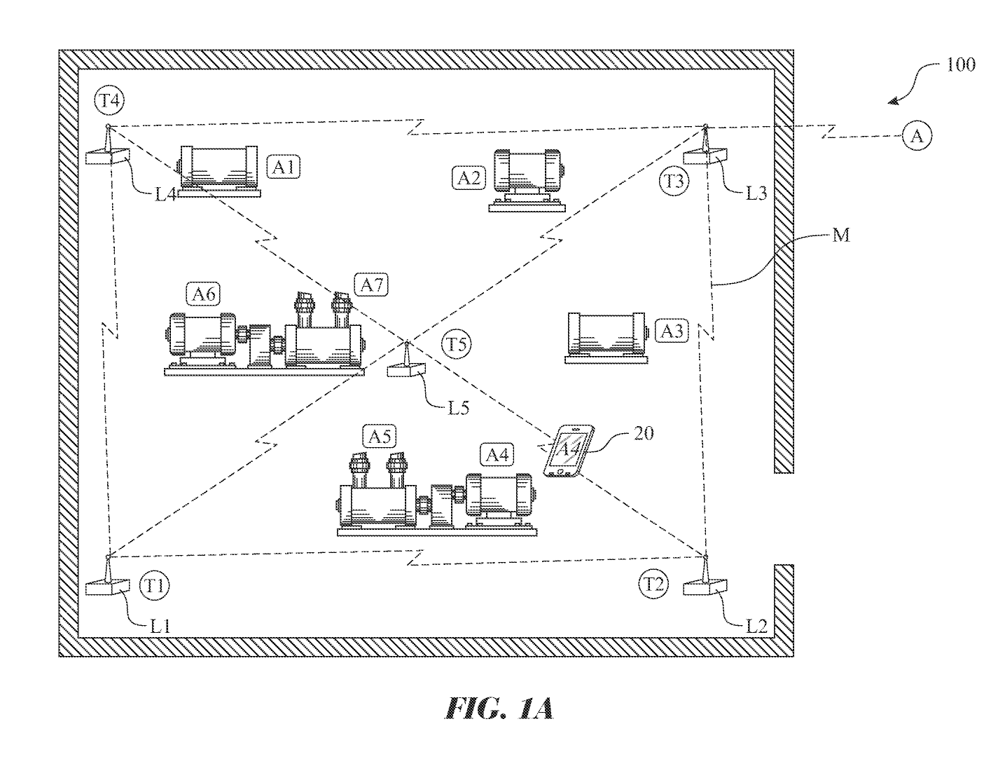

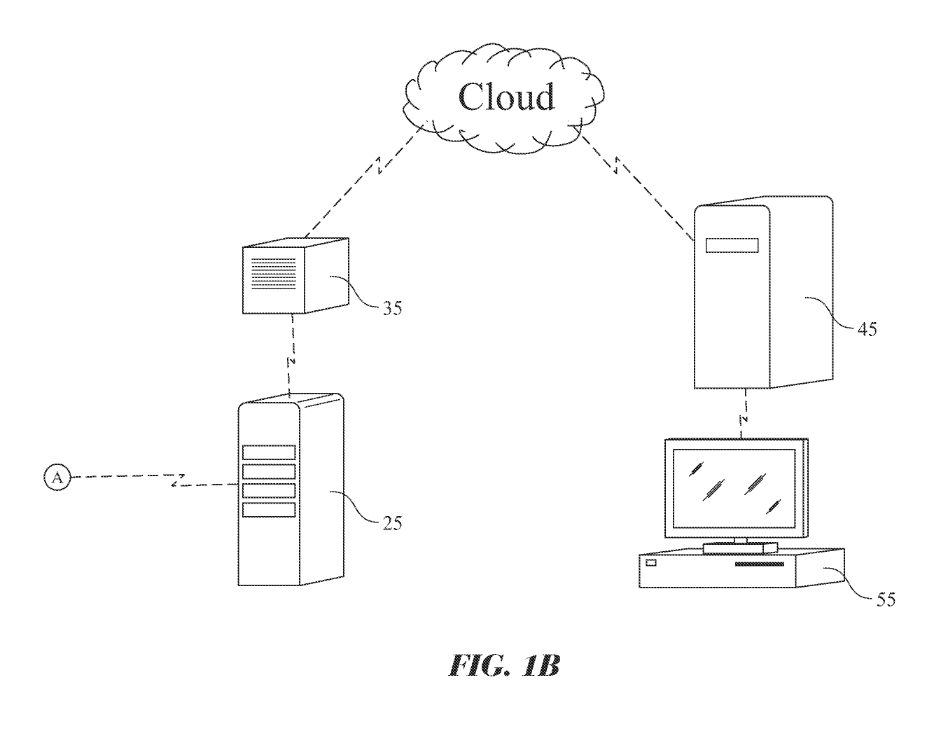

For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims.

First and second parts of system 100 for precisely locating an asset A in a physical plant 10 are illustrated in FIGS. 1A-1B (connected wirelessly from point A of FIG. 1A to FIG. 1B point A (A-A)). The proposed invention utilizes a system whereby precise triangulation is possible within a closed environment. Here in the present invention, a number of transmitters located at known locations in the plant forms a mesh that allows a hand held (mobile) device used by plant personnel to be triangulated to a precise location in the plant. Accordingly, the present system 100 provides a wireless mesh network M formed by a plurality of radio transmitter nodes Tₙ. The plurality of radio transmitter nodes Tₙ are located at a plurality of known locations Lₙ disposed throughout the physical plant 10. To be succinct, the wireless mesh network (WMN) M is a communications network made up of radio transmitter nodes Tₙ organized in a mesh topology.

As shown in FIG. 1A, there are five radio transmitter nodes T₁-T₅ shown located at five locations L₁-L₅ respectively. The coverage area of the radio transmitter nodes T₁-T₅ work together as a single network to form a mesh cloud. Access to the mesh cloud is dependent on the radio transmitter nodes T₁-T₅ working in harmony with each other to create the wireless mesh network M. When one radio transmitter node can no longer operate, the rest of the nodes can still communicate with each other, directly or through one or more intermediate radio transmitter nodes. Therefore, the wireless network M can self-form and self-heal. This makes for an extremely reliable network.

The system 100 further provides a hand held device 20 that has a GPS application loaded thereon. The hand held device 20 could be one of any phone device that uses BlueTooth Low Energy (BLE). With the GPS application, the hand held device 20 is enabled to triangulate to a precise location in the physical plant via the wireless mesh. A variety of application technologies that provide this type of triangulation exists, notably Apple's iBeacon. iBeacon is a unique application in that it exploits existing Bluetooth devices already present in mobile devices. For example, the iBeacon application can be loaded onto an Android phone, an Apple iPhone or an Apple iPad.

The precisely triangulated location is then overlaid on an asset map 15 that is displayed on the hand held device 20. The asset map includes all of the assets that fall within the range of the wireless mesh. Here, assets A1-A7 are shown. However, a plurality of assets A could reside within the wireless mesh. An asset could be set up as single or multiple assets.

The asset map 15 application may be stored in the hand held mobile device 20. The wireless mesh network M may also include a central system server or wireless gateway 25 that can route the wireless communications from the mesh network M to the Internet/Cloud. As such, the asset map 15 application may also be obtained through wireless connection from either the central system server 25 or an Internet Service Provider server 35.

Accordingly, knowing the location on the asset map then permits the device to display the particular asset a person is standing in front of as well as which particular part. The accuracy of the system is such that the hand held device can be located within a range of 20-40 cm of a particular location or asset disposed within the physical plant. This allows the application to differentiate between multiple assets positioned together. For example, the application can distinguish between assets A6 and A7. The accuracy of the application surprisingly allows the display on the hand held device to follow around the asset and show an aspect view of the asset when moved about.

The application could also be monitored online. FIG. 1B shows a computing device 45 connected to an application server 55 which is connected to the Internet. Accordingly, the hand held device can communicate with the computing device. Therefore, the computing device can monitor the application online. Further, the computing device could store data obtained online.

A route or fixed measurement instruction list is no longer necessary. Simply “walking the plant” and taking data is now possible because the mobile device can always determine which asset and what particular part of the asset was monitored. By simply walking past the asset the hand held device could update information on that asset. Additionally, by simply walking past the asset, the application could be configured to display life data for that asset. This information might include maintenance information but also process data.

Therefore, the application does not require an RFID tag, a QR code, a Bar code or a number plate to find/locate the appropriate asset point with the hand held device. These all have the possibility of fading away over time or otherwise get removed or destroyed, thereby making precise location more difficult or impossible.

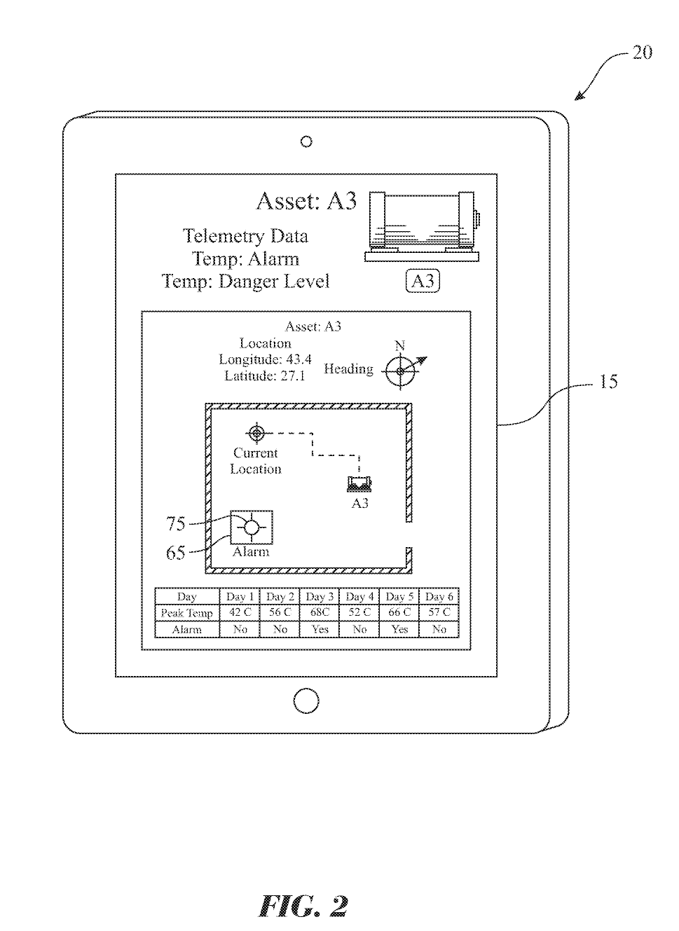

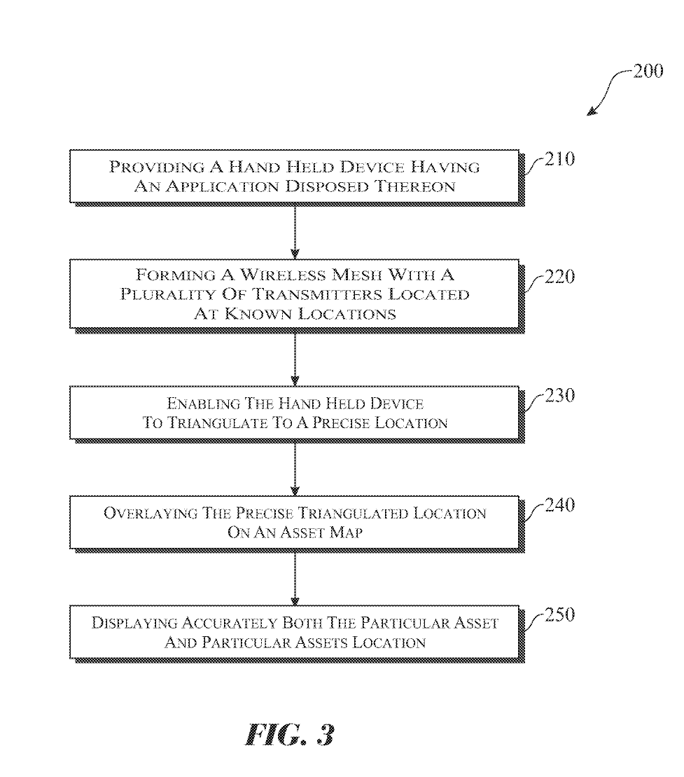

As shown in FIG. 2, the asset point could also be a measurement point that could provide telemetry data and temperature levels. The temperature levels could include peak, danger and alarm levels. These temperature levels could be taken, displayed and stored for any number of successive days. The telemetry data for a particular asset would typically include a location. The location would provide a heading, a longitudinal position and a latitudinal position. As shown in FIG. 3, the heading is typically provided in the form of a directional arrow displayed within a compass. As such, the heading is angular reading, where the heading angle of the device is typically illustrated with respect to true north. The longitudinal value is a geographic coordinate that specifies the east-west position of a point on the Earth's surface or in this case the east-west position within the physical plant. Conversely, the latitudinal value is a geographic coordinate that specifies the north-south position of a point on the Earth's surface or in this case the north-south position within the physical plant.

Therefore, when an observation is made by plant personnel, their precise location and heading can be stored along with the observation. This may be very helpful for data diagnosis and automation later on.

The system 100 described above can also be used to instruct plant personnel where to go next and verify that they have arrived. This information can in turn be used to improve route cycle time efficiency, track route progress and ensure route completeness.

The present invention can further be used to not only detect the users heading and instruct plant personnel where to go next, but can additionally determine that the user is going to an unsafe area 65 and provide them with a visual or combination visual/audible warning signal 75.

### Method of Operating the Device

A method 200 of operating a system for precisely locating an asset or measurement point in a physical plant is illustrated in FIG. 4. The method steps include providing a hand held device 20 having an application disposed thereon 210. Here, the application disposed on the hand held device 20 is the GPS iBeacon application previously disclosed and provided by Apple. In a second step 220, forming a wireless mesh M with a plurality of transmitters Tₙ located at known locations Lₙ disposed throughout the physical plant is provided. Here again, Assets A are disposed within a range of the wireless mesh M. The method further includes enabling the hand held device to triangulate to a precise location in the physical plant by virtue of the application and wireless mesh in step 230. In step 240, overlaying the precise triangulated location on an asset map displayed on the hand held device is provided. The final method step 250 provides displaying accurately both the particular asset and particular assets location by knowing its precise location overlaid onto the asset map.

1. A method of operating a system for precisely locating an asset or measurement point in a physical plant, comprising the steps of:
providing a hand held device having an application disposed thereon;
forming a wireless mesh with a plurality of transmitters located at known locations disposed throughout the physical plant;
enabling the hand held device to triangulate to a precise location in the physical plant by virtue of the application and wireless mesh;
overlaying the precise triangulated location on an asset map displayed on the hand held device, and
displaying accurately both the particular asset and particular assets location by knowing its precise location overlaid onto the asset map.

2. The method of operating a system for locating an asset or measurement point according to claim 1, wherein the particular assets location includes its longitude and latitude positions.

3. The method of operating a system for locating an asset or measurement point according to claim 1, further comprising a directional heading displayed on the hand held device generated by the last physical movement of the hand held device.

4. The method of operating a system for locating an asset or measurement point according to claim 1, further comprising an operator making an observation about an asset and having their precise location and heading stored along with their observation.

5. The method of operating a system for locating an asset or measurement point according to claim 1, further comprising a step of obtaining the asset map through a wireless connection from an internet/intranet server.

6. The method of operating a system for locating an asset or measurement point according to claim 1, further comprising a step of storing the asset map within the mobile data collector.

7. The method of operating a system for locating an asset or measurement point according to claim 1, further comprising a step of monitoring the application online.

8. The method of operating a system for locating an asset or measurement point according to claim 1, wherein the hand held device application communicates with a server application that in turn holds online data.

9. The method of operating a system for locating an asset or measurement point according to claim 1, further comprising a step of walking past the asset with the hand held device updates information on that asset.

10. The method of operating a system for locating an asset or measurement point according to claim 9, wherein when walking past the asset, the application is configured to display life data for that asset.

11. The method of operating a system for locating an asset or measurement point according to claim 1, further comprising a step of locating the hand held device within a range of 20-40 cm of a particular location or asset disposed within the physical plant.

12. The method of operating a system for locating an asset or measurement point according to claim 1, wherein the measurement point provides telemetry data.

13. The method of operating a system for locating an asset or measurement point according to claim 12, wherein the telemetry data includes peak, danger and alarm levels.

14. The method of operating a system for locating an asset or measurement point according to claim 1, wherein temperature levels are taken, displayed and stored for any number of successive days.

15. The method of operating a system for locating an asset or measurement point according to claim 12, wherein the telemetry data for a particular asset includes a location, the location providing a heading, a longitudinal position and a latitudinal position.

16. The method of operating a system for locating an asset or measurement point according to claim 15, wherein the heading is shown as a directional arrow displayed within a compass having north, south east and west divisions.

17. The method of operating a system for locating an asset or measurement point according to claim 15, wherein the precise device location and device heading of an observation made by a plant personnel is stored within the device along with the observation, and wherein the data and observation made may provide data diagnosis and automation at a later time.

18. The method of operating a system for locating an asset or measurement point according to claim 12, further comprising using the telemetry data to instruct plant personnel where to go next and verify that they have arrived.

19. The method of operating a system for locating an asset or measurement point according to claim 18, further comprising using the telemetry data to determine that the user is going to an unsafe area and provides the plant personnel with a warning signal.
